(19) United States
(12) Patent Application Publication
(10) Pub. No.: US 2024/0396286 A1
(43) Pub. Date: Nov. 28, 2024

(54) INTRACAVITY FREQUENCY DOUBLING FIBER LASER

(71) Applicant: FUJIAN HITRONICS TECHNOLOGIES, INC., Fuzhou (CN)

(72) Inventors: Guanglei Ding, Fuzhou (CN); Xiaxiong Tang, Fuzhou (CN); Shaofeng Zhang, Fuzhou (CN); Jiwu Ling, Fuzhou (CN)

(21) Appl. No.: 18/369,668

(22) Filed: Sep. 18, 2023

(30) Foreign Application Priority Data
May 24, 2023 (CN) 2023105907921

(51) Int. Cl. H01S 3/137; H01S 3/067; H01S 3/081; H01S 3/16

(52) U.S. Cl. CPC H01S 3/137; H01S 3/06712; H01S 3/0811; H01S 3/1603; H01S 3/1673; H01S 3/10023

(57) ABSTRACT

An intracavity frequency doubling fiber laser includes pump sources, optical beam combiners and a bidirectional optical amplifier; a first fiber collimator, a first optical polarization rotating device, a polarizer, a laser frequency doubling device and a laser cavity mirror being arranged on one side of the bidirectional optical amplifier along an optical path in sequence; a second fiber collimator, a polarization beam splitting device, a second optical polarization rotating device and a reflection device being arranged on the other side of the bidirectional optical amplifier along the optical path in sequence; the disclosure has small size and low cost, which can output different wavebands of frequency-doubled lasers by replacing components.

### CROSS-REFERENCE TO RELATED APPLICATION

This application claims priority from the Chinese patent application 2023105907921 filed May 24, 2023, the content of which is incorporated herein in the entirety by reference.

### TECHNICAL FIELD

The present disclosure relates to the technical field of laser, in particular to an intracavity frequency doubling fiber laser.

### BACKGROUND ART

At present, nonlinear frequency conversion technology refers to that when fundamental frequency laser is incident on a nonlinear optical crystal, a nonlinear effect can be excited under the condition of meeting a phase matching condition, so as to generate a new wavelength laser, which expands the wavelength range of a laser source. Various wavelengths of lasers can be obtained by laser frequency doubling; for example, red, green, blue, ultraviolet and deep-ultraviolet lasers can be generated, which have broad application prospects and markets in terms of large screen laser display, laser medical treatment, high-density storage, microelectronics, micromechanics, laser holography, pumping tunable optical parametric laser and the like. Generally, visible light and ultraviolet laser are achieved by intracavity or extracavity frequency doubling of a solid laser, and the intracavity frequency doubling has a higher conversion efficiency; and the extracavity single-pass frequency doubling is relatively simple in structure, but low in conversion efficiency. The fiber laser has the advantages of high conversion efficiency, high beam quality, convenient thermal management, compact structure, convenient maintenance and the like, and can serve as a fundamental frequency laser source of an intracavity frequency doubling laser. However, the intracavity frequency doubling usually requires polarization maintaining of laser in the cavity, and therefore the cost is relatively high when frequency doubling in the cavity is achieved by using a polarization maintaining fiber laser made of an all-polarization maintaining device.

### SUMMARY

In order to solve the technical problems in the prior art, the present disclosure provides an intracavity frequency doubling fiber laser.

In order to solve the technical problems in the prior art, the present disclosure provides the following technical solution:

An intracavity frequency doubling fiber laser includes pump sources, optical beam combiners and a bidirectional optical amplifier. A first fiber collimator, a first optical polarization rotating device, a polarizer, a laser frequency doubling device and a laser cavity mirror are arranged on one side of the bidirectional optical amplifier along an optical path in sequence; a second fiber collimator, a polarization beam splitting device, a second optical polarization rotating device and a reflection device are arranged on the other side of the bidirectional optical amplifier along the optical path in sequence;

The first and second optical polarization rotating devices are configured to rotate fundamental frequency laser with a polarization direction of 45° in a nonreciprocal manner.

The laser frequency doubling device is configured to convert the fundamental frequency laser with a frequency of ω into frequency-doubled laser with a frequency of 20.

The polarization beam splitting device is configured to split the fundamental frequency laser into an S-polarized laser and a P-polarized laser.

Pump light generated by the pump sources is coupled into the bidirectional optical amplifier by the optical beam combiners, and the bidirectional optical amplifier absorbs the pump light and generates, amplifies and outputs the fundamental frequency laser.

The fundamental frequency laser output from one side of the bidirectional optical amplifier enters the first optical polarization rotating device to be rotated with a polarization direction of 45° in a non-reciprocal manner after being collimated by the first fiber collimator, and then enters the polarizer; the fundamental frequency laser that has been polarized in the same direction as a transmission axis direction of the polarizer enters the laser frequency doubling device through the polarizer, part of polarized fundamental frequency laser therein is converted into frequency-doubled laser, and the frequency-doubled laser is output from the laser cavity mirror; polarized fundamental frequency laser which is not converted into the frequency-doubled laser is reflected back by the laser cavity mirror along the original optical path, reaches the first optical polarization rotating device in the incident manner after passing through the laser frequency doubling device and the polarizer in sequence, rotated with a polarization direction of 45° in the non-reciprocal manner, and then enters the bidirectional optical amplifier;

The fundamental frequency laser output from the other side of the bidirectional optical amplifier enters the polarization beam splitting device in the incident manner after being collimated by the second fiber collimator, then enters the second optical polarization rotating device after being transmitted through the polarization beam splitting device, rotated with a polarization direction of 45° in the non-reciprocal manner, and then enters the reflection device in the incident manner; and it is reflected back by the reflection device to the second optical polarization rotating device, rotated with a polarization direction of 45° in the non-reciprocal manner again, and then enters the bidirectional optical amplifier through the polarization beam splitting device and the second fiber collimator in sequence.

Furthermore, after the fundamental frequency laser output from the bidirectional optical amplifier enters the polarization beam splitting device in the incident manner, its refraction and reflection optical path among the polarization beam splitting device, the second optical polarization rotating device and the reflection device is square-shaped.

Furthermore, the polarization beam splitting device consists of a prism A, a parallelogramic prism and a prism B which are fit with each other from top to bottom in sequence. Cross sections of the prism A and the prism B are in a right triangle or a right trapezoid, and an included angle between an inclined plane and a right-angle plane of each of the prism A and the prism B is 45°; and the reflection device is a 45° isosceles right-angle prism.

Furthermore, each of the first and second optical polarization rotating devices includes a Faraday rotator.

Furthermore, the pump sources, the optical beam combiners and the bidirectional optical amplifier form forward pumping or backward pumping or bidirectional pumping.

Furthermore, the polarizer is a Gran Polarizer or a polarization beam splitter.

Furthermore, the laser frequency doubling device includes a frequency doubling crystal, and the frequency doubling crystal applies an I-type critical phase matching mode.

Furthermore, the polarization beam splitting device is a polarization beam splitter set or a pure YVO₄ crystal.

Furthermore, the bidirectional optical amplifier includes a gain fiber provided with gain ions, and the gain ions include any one or more of neodymium ions, erbium ions, germanium ions, praseodymium ions, holmium ions, europium ions, ytterbium ions, dysprosium ions and thulium ions.

Furthermore, a laser filtering device configured to filter out laser that fall outside a central wavelength of the fundamental frequency laser is arranged between the second optical polarization rotating device and the reflection device.

The present disclosure has the advantages and positive effects that the oscillation of multi-longitudinal-mode and low-noise linearly polarized fundamental frequency laser is achieved by using the optical polarization rotating devices and the polarizer in the present disclosure, and the frequency-doubled laser is generated by an intracavity laser frequency conversion device; and finally stable frequency-doubled laser is output from the cavity mirror. The present disclosure features small size and low cost. Different wavebands of frequency-doubled lasers can be output by replacing different laser filtering devices and bidirectional optical amplifiers.

### BRIEF DESCRIPTION OF THE DRAWINGS

FIG. 1 is a structural schematic diagram of an intracavity frequency doubling fiber laser with backward pumping in the present disclosure.

FIG. 2 is a structural schematic diagram of another intracavity frequency doubling fiber laser with backward pumping in the present disclosure.

FIG. 3 is a structural schematic diagram of an intracavity frequency doubling fiber laser with forward pumping in the present disclosure.

FIG. 4 is a structural schematic diagram of another intracavity frequency doubling fiber laser with forward pumping in the present disclosure.

FIG. 5 is a structural schematic diagram of an intracavity frequency doubling fiber laser with bidirectional pumping in the present disclosure.

FIG. 6 is a structural schematic diagram of another intracavity frequency doubling fiber laser with bidirectional pumping in the present disclosure.

In the drawings: 1. laser cavity mirror; 2. laser frequency doubling device; 3. polarizer; 4. first optical polarization rotating device; 5. first fiber collimator; 6. bidirectional optical amplifier; 7. first optical beam combiner; 8. first pump source; 9. second fiber collimator; 10. polarization beam splitting device; 11. second optical polarization rotating device; 12. laser filtering device; 13. reflection device; 14. second pump source; 15. second optical beam combiner.

### DETAILED DESCRIPTION OF THE PRESENT DISCLOSURE

The present disclosure will be described in detail below with reference to the drawings and the embodiments. It should be understood that the preferred embodiments described herein are only for explaining the present disclosure, but are not for limiting the present disclosure.

In the description of the present disclosure, orientation or position relationships indicated by terms “upper”, “lower”, “front”, “rear”, “left”, “right”, “vertical”, “horizontal”, “top”, “bottom”, and the like are orientation or position relationships shown in the drawings, are adopted not to require that the present disclosure must be structured and operated in specific orientations but only to conveniently describe the present disclosure and thus should not be understood as limits to the present disclosure. The terms “connection” and “link” used in the present disclosure should be understood in a broad sense, for example, “connection” may be fixed connection or detachable connection; and it may be direct connection or indirect connection through an intermediate component. For those ordinarily skilled in the art, the specific meaning of the above terms can be understood according to specific circumstances.

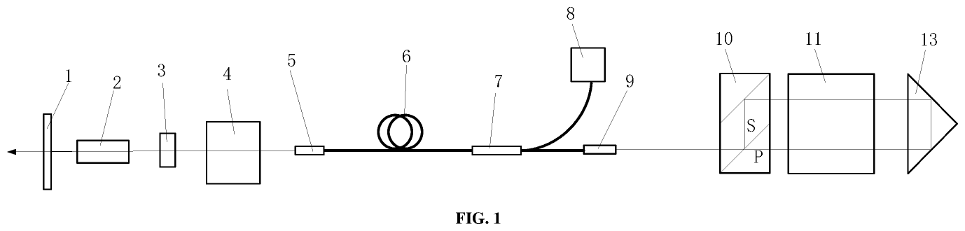

Referring to FIGS. 1-6, an intracavity frequency doubling fiber laser includes pumping sources, optical beam combiners and a bidirectional optical amplifier 6; and a first fiber collimator 5, a first optical polarization rotating device 4, a polarizer 3, a laser frequency doubling device 2 and a laser cavity mirror 1 are arranged on one side of the bidirectional optical amplifier 6 along an optical path in sequence; and a second fiber collimator 9, a polarization beam splitting device 10, a second optical polarization rotating device 11 and a reflection device 13 are arranged on the other side of the bidirectional optical amplifier 6 along the optical path in sequence.

The pump sources are configured to generate pump light.

The optical beam combiners are configured to couple the pump light to the bidirectional optical amplifier 6.

The bidirectional optical amplifier 6 is configured to absorb the pump light, and generate and amplify fundamental frequency laser.

The first and second fiber collimators are configured to collimate the laser.

The first and second optical polarization rotating devices are configured to rotate the polarization direction of the fundamental frequency laser by 45° in a nonreciprocal manner.

The polarizer 3 is configured to allow the fundamental frequency laser in one polarization direction to pass; the laser cavity mirror 1 is configured to refract back the fundamental frequency laser and output frequency-doubled laser.

The laser frequency doubling device 2 is configured to convert the fundamental frequency laser with a frequency of ω into the frequency-doubled laser with a frequency of 20 after the fundamental frequency laser passes through the laser frequency doubling device, and separate the fundamental frequency laser and the frequency-doubled laser.

The polarization beam splitting device 10 is configured to split the fundamental frequency laser into an S-polarized laser and a P-polarized laser;

The reflection device 13 is configured to reflect the fundamental frequency laser which passes through the second optical polarization rotating device 11.

The laser cavity mirror 1 is configured to refract back the fundamental frequency laser and output the frequency-doubled laser.

The laser cavity mirror 1 is coated with a fundamental frequency laser high-reflection film and a frequency-doubled laser transmission film; the reflection device 13 is coated with a fundamental frequency laser high-reflection film; the pump sources output pump light to the optical beam combiners; and the polarization of the polarizer 3 is in the same direction as an optical axis direction of the laser frequency doubling device 2.

Pump light generated by the pump sources is coupled into the bidirectional optical amplifier 6 by the optical beam combiners, and the bidirectional optical amplifier 6 absorbs the pump light and generates, amplifies and outputs the fundamental frequency laser.

The fundamental frequency laser output from one side of the bidirectional optical amplifier 6 enters the first optical polarization rotating device 4 after being collimated by the first fiber collimator 5, rotated by the first optical polarization rotating device 4 with a polarization direction of 45° in a non-reciprocal manner, and then enters the polarizer 3; the fundamental frequency laser that has been polarized in the same direction as a transmission axis direction of the polarizer 3 enters the laser frequency doubling device 2 through the polarizer 3, and part of polarized fundamental frequency laser in the laser frequency doubling device 2 is converted into the frequency-doubled laser, and the frequency-doubled laser is output from the laser cavity mirror 1; polarized fundamental frequency laser which is not converted into the frequency-doubled laser is reflected by the laser cavity mirror 1 along the original optical path, enters the first optical polarization rotating device 4 in the incident manner after passing through the laser doubling device 2 and the polarizer 3 in sequence, rotated with a polarization direction of 45° in the non-reciprocal manner, and then enters the bidirectional optical amplifier 6.

The fundamental frequency laser output from the other side of the bidirectional optical amplifier 6 enters the polarization beam splitting device 10 in the incident manner after being collimated by the second fiber collimator 9, enters the second optical polarization rotating device 11 after being transmitted through the polarization beam splitting device 10, rotated with a polarization direction of 45° in the non-reciprocal manner, and then enters the reflection device 13 in the incident manner; it is reflected back by the reflection device 13 to the second optical polarization rotating device 11, rotated by 45° in the non-reciprocal manner again, and then enters the polarization beam splitting device 10; and the fundamental frequency laser enters the bidirectional optical amplifier 6 after being processed by the polarization beam splitting device 10.

Preferably, after the fundamental frequency laser output from the bidirectional optical amplifier 6 enters the polarization beam splitting device 10 in the incident manner, its refraction and reflection optical path among the polarization beam splitting device 10, the second optical polarization rotating device 11 and the reflection device 13 are square-shaped.

Preferably, the polarization beam splitting device 10 consists of a prism A, a parallelogramic prism and a prism B which are fit with each other from top to bottom in sequence. Cross sections of the prism A and the prism B may be in a right triangle or a right trapezoid, and an included angle between an inclined plane and a right-angle plane of each of the prism A and the prism B is 45°; and the reflection device 13 may be a 45° isosceles right-angle prism.

Preferably, each of the first optical polarization rotating device 4 and the second optical polarization rotating device 11 includes a Faraday rotator.

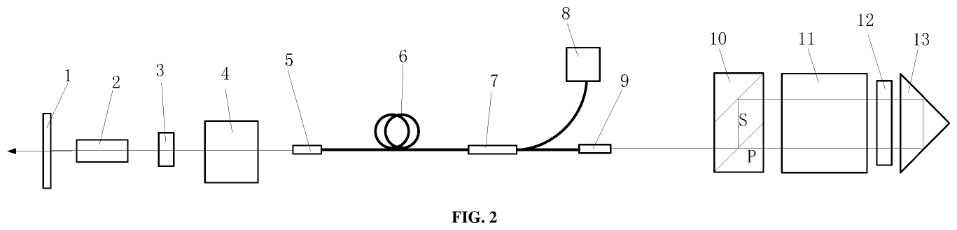

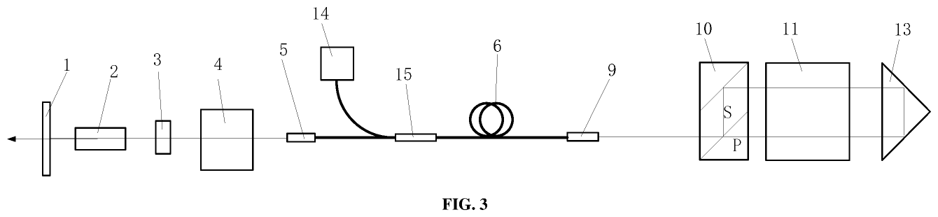

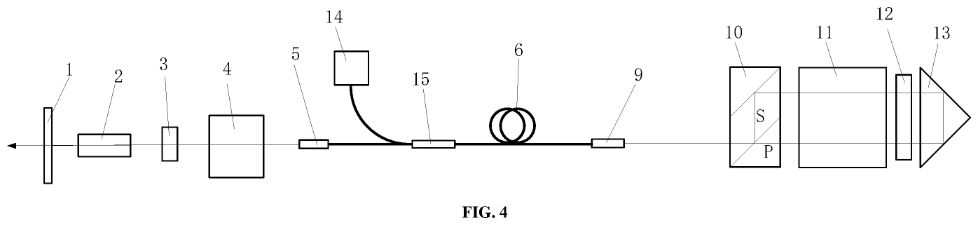

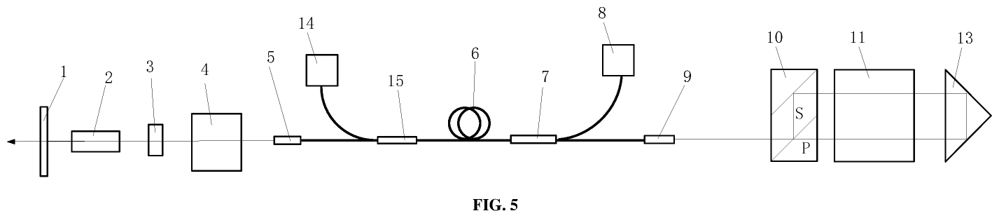

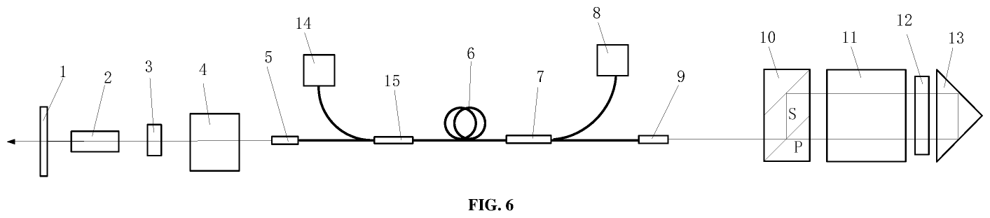

Preferably, the pump sources, the optical beam combiners and the bidirectional optical amplifier 6 may constitute forward pumping or backward pumping or bidirectional pumping. Referring to FIG. 1 and FIG. 2, the first pump source 8, the first optical beam combiner 7 and the bidirectional optical amplifier 6 constitute backward pumping which is also called reverse pumping. Referring to FIG. 3 and FIG. 4, the second pump source 14, the second optical beam combiner 15 and the bidirectional optical amplifier 6 constitute forward pumping which is also called positive pumping. Referring to FIG. 5 and FIG. 6, the first pump source 8, the first optical beam combiner 7, the second pump source 14, the second optical beam combiner 15 and the bidirectional optical beam combiner 6 constitute bidirectional pumping.

Preferably, the polarizer 3 may be a Gran Polarizer or a polarization beam splitter. The polarization direction of the Gran Polarizer is the same as the optical axis direction of a lithium triborate (LBO) crystal and form a polarization direction of 45° with the P polarization direction.

Preferably, the laser frequency doubling device 2 may include a frequency doubling crystal, and the frequency doubling crystal applies an I-type critical phase matching mode. The laser frequency doubling device 2 may adopt LBO (lithium triborate high-power ultraviolet frequency doubling crystal), and the LBO applies the I-type critical phase matching mode.

Preferably, the polarization beam splitting device 10 may be a polarization beam splitter set or a pure YVO₄ crystal.

Preferably, the bidirectional optical amplifier 6 may include a gain fiber provided with gain ions, and the gain ions include any one or more of neodymium ions, erbium ions, germanium ions, praseodymium ions, holmium ions, europium ions, ytterbium ions, dysprosium ions and thulium ions. The bidirectional optical amplifier 6 may adopt a ytterbium ion-doped fiber.

Preferably, a laser filtering device 12 configured to filter out lasers that fall outside a central wavelength of the fundamental frequency laser may be arranged between the second optical polarization rotating device 11 and the reflection device 13. The laser filtering device 12 may adopt a filter.

All the laser cavity mirror 1, the laser frequency doubling device 2, the polarizer 3, the first optical polarization rotating device 4, the first fiber collimator 5, the bidirectional optical amplifier 6, the first optical beam combiner 7, the first pump source 8, the second optical beam combiner 14, the second pump source 15, the second fiber collimator 9, the polarization beam splitting device 10, the second optical polarization rotating device 11, the laser filtering device 12, and the reflection device 13 may apply components or structural assemblies in the prior art, or be structured with the components or structural assemblies in the prior art by a conventional technical means.

The working principles of the present disclosure will be further described with a preferred embodiment shown in FIG. 1:

FIG. 1 is a structural schematic diagram of an intracavity frequency doubling fiber laser with backward pumping (reverse pumping) in the present disclosure, and the intracavity frequency doubling fiber laser includes a laser cavity mirror 1, a laser frequency doubling device 2, a polarizer 3, a first optical polarization rotating device 4, a first fiber collimator 5, a bidirectional optical amplifier 6, a first optical beam combiner 7, a first pump source 8, a second fiber collimator 9, a polarization beam splitting device 10, a second optical polarization rotating device 11, and a reflection device 13.

The first pump source 8, the first optical beam combiner 7 and the bidirectional optical amplifier 6 constitute backward pumping (reverse pumping). The pump source 8 emits pump light, and the pump light enters the first optical beam combiner 7 in the incident manner. The pump light is coupled into the bidirectional optical amplifier 6 by the first optical beam combiner 7. After absorption of the pump light by the bidirectional optical amplifier, population inversion is formed for generating and amplifying the fundamental frequency laser, and the fundamental frequency laser is split into the P-polarized fundamental frequency laser and the S-polarized fundamental frequency laser.

The first optical polarization rotating device 4 and the second optical polarization rotating device 11 adopt Faraday rotators. The Gran Polarizer is used as the polarizer, and the polarization direction of the Gran Polarizer is the same as the optical axis direction of LBO and forms a polarization direction of 45° with the P polarization direction. The laser frequency doubling device 2 adopts LBO (lithium triborate high-power ultraviolet frequency doubling crystal), and the LBO applies the I-type critical phase matching mode. The polarization beam splitting device 10 adopts a polarization beam splitter set. The bidirectional optical amplifier 6 adopts a ytterbium ion-doped fiber.

The P-polarized fundamental frequency laser enters the first optical polarization rotating device 4 in the incident manner after passing through the first fiber collimator 5. The first optical polarization rotating device 4 is configured to clockwise rotate the P-polarized fundamental frequency laser with a polarization direction of 45° in a non-reciprocal manner, and the 45° rotated fundamental frequency laser enters the polarizer 3 in the incident manner. The polarizer 3 is configured to screen the polarization directions of the fundamental frequency laser, and only the polarized fundamental frequency laser with a polarization direction of 45° to the P polarization direction penetrates, and then enters the laser frequency doubling device 2 in the incident manner to obtain the polarized frequency-doubled laser after being subjected to frequency doubling by the laser frequency doubling device 2; and then, the polarized frequency-doubled laser enters the laser cavity mirror 1 in the incident manner, and transmitted and output from the laser cavity mirror 1. As a frequency doubling conversion process of the laser frequency doubling device 2 cannot achieve 100% conversion, part of 45° polarized fundamental frequency laser is not converted, and the fundamental frequency laser with a polarization direction of 45° which is not processed by frequency doubling is reflected by the laser cavity mirror 1 along the original optical path, and enters the first optical polarization rotating device 4 in the incident manner after passing through the laser frequency doubling device 2 and the polarizer 3; the fundamental frequency laser with a polarization direction of 45° is clockwise rotated by the first optical polarization rotating device 4 by 45° in the non-reciprocal manner, so as to convert into the S-polarized fundamental frequency laser. The S-polarized fundamental frequency laser enters the polarization beam splitting device 10 in the incident manner after passing through the first fiber collimator 5, the bidirectional optical amplifier 6, the first optical beam combiner 7 and the second fiber collimator 9. The S-polarized fundamental frequency laser is reflected by the polarization beam splitting device 10, and enters the second optical polarization rotating device 11 in the incident manner after penetrating an upper half part of the polarization beam splitting device 10. The second optical polarization rotating device 11 is configured to clockwise rotate the polarization of the S-polarized fundamental frequency laser by 45° in the non-reciprocal manner, and the fundamental frequency laser rotated with a polarization direction of 45° enters the reflection device 13 in the incident manner, and the reflection device 13 is a 45° isosceles right-angle prism. After being reflected by the 45° isosceles right-angle prism, the fundamental frequency laser passes through the second optical polarization rotating device 11 again, and accordingly the fundamental frequency laser rotated with a polarization direction of 45° is converted into the P-polarized fundamental frequency laser. The P-polarized fundamental frequency laser is incident from a lower half part of the polarization beam splitting device 10, and is transmitted by the polarization beam splitting device 10. The P-polarized fundamental frequency laser is amplified after passing through the second fiber collimator 9, the first optical beam combiner 7 and the bidirectional optical amplifier 6 again, and the P-polarized laser is transmitted again in the laser cavity (the laser cavity comprises laser cavity mirror 1 and the reflection device 13) according to the above optical path after passing through the first fiber collimator 5. The fundamental frequency laser oscillates and is transmitted back and forth between the laser cavity mirror 1 and the 45° isosceles right-angle prism, and the frequency-doubled laser is continuously output from the laser cavity mirror 1.

The S-polarized fundamental frequency laser enters the first optical polarization rotating device 4 in the incident manner after passing through the first fiber collimator 5. The first optical polarization rotating device 4 is configured to clockwise rotate the polarization of the S-polarized fundamental frequency laser by 45° in the non-reciprocal manner, and the rotated 45° fundamental frequency laser enters the polarizer 3 in the incident manner. The polarizer 3 is configured to screen the polarization directions of the fundamental frequency laser, and only the polarized fundamental frequency laser which forms 45° with the P polarization direction penetrates, which is completely consumed by the polarizer 3 after the S polarization is rotated by 45°, and cannot be transmitted in the laser cavity.

FIG. 2 is a structural schematic diagram of another intracavity frequency doubling fiber laser with backward pumping (reverse pumping) in the present disclosure, and a laser filtering device 12 is additionally arranged therein between the second optical polarization rotating device 11 and the reflection device 13 based on the structure shown in FIG. 1, and configured to filter out lasers that fall outside a central wavelength from the fundamental frequency laser passing through the laser filtering device 12.

FIG. 3 is a structural schematic diagram of an intracavity frequency doubling fiber laser with forward pumping (positive pumping) in the present disclosure, and the intracavity frequency doubling fiber laser includes a laser cavity mirror 1, a laser frequency doubling device 2, a polarizer 3, a first optical polarization rotating device 4, a first fiber collimator 5, a bidirectional optical amplifier 6, a second optical beam combiner 14, a second pump source 15, a second fiber collimator 9, a polarization beam splitting device 10, a second optical polarization rotating device 11, and a reflection device 13.

In FIG. 3, the second pump source 14, the second optical beam combiner 15 and the bidirectional optical amplifier 6 form forward pumping (positive pumping). The working principles thereof are the same as those of the intracavity frequency doubling fiber laser shown in FIG. 1.

FIG. 4 is a structural schematic diagram of another intracavity frequency doubling fiber laser with forward pumping (positive pumping) in the present disclosure, and a laser filtering device 12 is additionally arranged therein between the second optical polarization rotating device 11 and the reflection device 13 based on the structure shown in FIG. 3.

FIG. 5 is a structural schematic diagram of an intracavity frequency doubling fiber laser with bidirectional pumping in the present disclosure, and the intracavity frequency doubling fiber laser includes a laser cavity mirror 1, a laser frequency doubling device 2, a polarizer 3, a first optical polarization rotating device 4, a first fiber collimator 5, a bidirectional optical amplifier 6, a first optical beam combiner 7, a first pump source 8, a second optical beam combiner 14, a second pump source 15, a second fiber collimator 9, a polarization beam splitting device 10, a second optical polarization rotating device 11, and a reflection device 13.

The structure of the intracavity frequency doubling fiber laser shown in FIG. 5 is a structure combination of the intracavity frequency doubling fiber laser with backward pumping shown in FIG. 1 and the intracavity frequency doubling fiber laser with forward pumping shown in FIG. 3; where, the bidirectional optical amplifier 6, the first optical beam combiner 7, the first pump source 8, the second optical beam combiner 14, and the second pump source 15 form bidirectional pumping, and the working principles thereof are basically the same as those of the intracavity frequency doubling fiber laser shown in FIG. 1.

FIG. 6 is a structural schematic diagram of another intracavity frequency doubling fiber laser with bidirectional pumping in the present disclosure, and a laser filtering device 12 is additionally arranged therein between the second optical polarization rotating device 11 and the reflection device 13 based on the structure shown in FIG. 5.

The above described embodiments are merely descriptive of the technical thoughts and characteristics of the present disclosure, and are intended to enable those skilled in the art to understand the contents of the present disclosure and implement it accordingly, which should not be construed as limiting the patent scope of the present disclosure; and equivalent variations or modifications made within the spirit disclosed by the present disclosure still fall within the patent scope of the present disclosure.

We claim:

1. An intracavity frequency doubling fiber laser includes pump sources, optical beam combiners and a bidirectional optical amplifier (6); a first fiber collimator (5), a first optical polarization rotating device (4), a polarizer (3), a laser frequency doubling device (2) and a laser cavity mirror (1) being arranged on one side of the bidirectional optical amplifier (6) along an optical path in sequence; a second fiber collimator (9), a polarization beam splitting device (10), a second optical polarization rotating device (11) and a reflection device (13) being arranged on the other side of the bidirectional optical amplifier (6) along the optical path in sequence;
the first and second optical polarization rotating devices being configured to rotate fundamental frequency laser with a polarization direction of 45° in a nonreciprocal manner;
the laser frequency doubling device (2) being configured to convert the fundamental frequency laser with a frequency of ω into frequency-doubled laser with a frequency of 20;
the polarization beam splitting device (10) being configured to split the fundamental frequency laser into an S-polarized laser and a P-polarized laser;
pump light generated by the pump sources being coupled to the bidirectional optical amplifier (6) by the optical beam combiners, and the bidirectional optical amplifier (6) absorbs the pump light and generates, amplifies and outputs the fundamental frequency laser;
the fundamental frequency laser output from one side of the bidirectional optical amplifier (6) enters the first optical polarization rotating device (4) to be rotated with a polarization direction of 45° in a non-reciprocal manner after being collimated by the first fiber collimator (5), and then enters the polarizer (3); the fundamental frequency laser that has been polarized in the same direction as a transmission axis direction of the polarizer (3) enters the laser frequency doubling device (2) through the polarizer (3), part of polarized fundamental frequency laser therein is converted into frequency-doubled laser, and the frequency-doubled laser is output from the laser cavity mirror (1);
polarized fundamental frequency laser which is not converted into the frequency-doubled laser is reflected back by the laser cavity mirror (1) along the original optical path, reaches the first optical polarization rotating device (4) in the incident manner after passing through the laser frequency doubling device (2) and the polarizer (3) in sequence, rotated with a polarization direction of 45° in the non-reciprocal manner, and then enters the bidirectional optical amplifier (6);
the fundamental frequency laser output from the other side of the bidirectional optical amplifier (6) enters the polarization beam splitting device (10) in the incident manner after being collimated by the second fiber collimator (9), then enters the second optical polarization rotating device (11) after being transmitted through the polarization beam splitting device (10), rotated with a polarization direction of 45° in the non-reciprocal manner, and then enters the reflection device (13) in the incident manner; and it is reflected back by the reflection device (13) to the second optical polarization rotating device (11), rotated with a polarization direction of 45° in the non-reciprocal manner again, and then enters the bidirectional optical amplifier (6) through the polarization beam splitting device (10) and the second fiber collimator (9) in sequence.

2. The intracavity frequency doubling fiber laser according to claim 1, wherein, the fundamental frequency laser output from the bidirectional optical amplifier (6), and enters the polarization beam splitting device (10) in the incident manner, its refraction and reflection optical path among the polarization beam splitting device (13), the second optical polarization rotating device (11) and the reflection device (13) is square-shaped.

3. The intracavity frequency doubling fiber laser according to claim 1, wherein the polarization beam splitting device (10) consists of a prism A, a parallelogramic prism and a prism B which are fit with each other from top to bottom in sequence; cross sections of the prism A and the prism B are in a right triangle or a right trapezoid, and an included angle between an inclined plane and a right-angle plane of each of the prism A and the prism B is 45°; and the reflection device is a 45° isosceles right-angle prism.

4. The intracavity frequency doubling fiber laser according to claim 1, wherein each of the first and second optical polarization rotating devices includes a Faraday rotator.

5. The intracavity frequency doubling fiber laser according to claim 1, wherein the pump sources, the optical beam combiners and the bidirectional optical amplifier (6) form forward pumping or backward pumping or bidirectional pumping.

6. The intracavity frequency doubling fiber laser according to claim 1, wherein the polarizer (3) is a Gran Polarizer or a polarization beam splitter.

7. The intracavity frequency doubling fiber laser according to claim 1, wherein the laser frequency doubling device (2) includes a frequency doubling crystal, and the frequency doubling crystal applies an I-type critical phase matching mode.

8. The intracavity frequency doubling fiber laser according to claim 1, wherein the polarization beam splitting device (10) is a polarization beam splitter set or a pure YVO₄ crystal.

9. The intracavity frequency doubling fiber laser according to claim 1, wherein the bidirectional optical amplifier (6) includes a gain fiber provided with gain ions, and the gain ions include any one or more of neodymium ions, erbium ions, germanium ions, praseodymium ions, holmium ions, europium ions, ytterbium ions, dysprosium ions and thulium ions.

10. The intracavity frequency doubling fiber laser according to claim 1, wherein a laser filtering device (12) configured to filter out laser that fall outside a central wavelength of the fundamental frequency laser is arranged between the second optical polarization rotating device (11) and the reflection device (13).
